(19) United States
(12) Patent Application Publication
(10) Pub. No.: US 2023/0175976 A1
(43) Pub. Date: Jun. 8, 2023

(54) METHOD AND DEVICE FOR INSPECTING CONTAINERS

(71) Applicant: KRONES AG, Neutraubling (DE)

(72) Inventors: Herbert KOLB, Hausen (DE); Stefan PIANA, Koefering (DE); Alexander HEWICKER, Woerth an der Donau (DE); Judith MENGELKAMP, Obertraubling (DE)

(21) Appl. No.: 17/997,012

(22) PCT Filed: Apr. 14, 2021
(86) PCT No.: PCT/EP2021/059685

§ 371 Date: Oct. 24, 2022

(30) Foreign Application Priority Data
Apr. 24, 2020 (DE) 10 2020 111 252.1

(51) Int. Cl. G01N 21/90; G01N 21/88

(52) U.S. Cl. CPC G01N 21/90; G01N 21/8851; G01N 2021/8883

(57) ABSTRACT

A method for inspecting containers, wherein the containers are transported in the form of a container mass flow by a transporter and are recorded as first measurement data by a first inspection unit and as second measurement data by a second inspection unit, wherein the first measurement data and the second measurement data are evaluated jointly by an evaluation unit using an evaluation method operating based on artificial intelligence to give output data, in order to ascertain an inspection result, such as for example a fill level, from the output data.

### CROSS REFERENCE TO RELATED APPLICATIONS

The present application is a U.S. National Phase of International Application No. PCT/EP2021/059685 entitled “METHOD AND DEVICE FOR INSPECTING CONTAINERS,” and filed on Apr. 14, 2021. International Application No. PCT/EP2021/059685 claims priority to German Patent Application No. 10 2020 111 252.1 filed on Apr. 24, 2020. The entire contents of each of the above-listed applications are hereby incorporated by reference for all purposes.

### TECHNICAL FIELD

The invention relates to a method and a device for inspecting containers.

### BACKGROUND AND SUMMARY

Methods and devices for inspecting containers are known in which the containers are transported with a transporter as a container mass flow and are recorded with a first inspection unit as first measurement data and with a second inspection unit as second measurement data in order to deliver information about the same inspection result, such as, for example, a fill level of the containers. Usually, the first measurement data and the second measurement data are evaluated separately and the results are combined, for example, with fuzzy logic.

Moreover, the evaluation of the first measurement data and the second measurement data is usually carried out with an evaluation unit that works on the basis of conventional evaluation methods and that must be adapted to the respective container types and/or varieties with parameters. Moreover, the combination of results must be determined and set up explicitly and/or during the installation or development of the device.

DE 10 2010 004972 A1 discloses a method for inspecting containers, wherein the containers are transported with a transport device along a predetermined path, a first area of the containers inspected by means of a first inspection device and a second area of the containers inspected by means of a second inspection device. The first and second inspection devices each output data that is characteristic of the inspected areas. The first data and the second data are associated with one another.

DE 10 2004 053567 A1 discloses a method for determining the integrity of a product in a container, wherein a predetermined feature of the product in the container is determined by means of a first measurement method in which a first physical property of the product is examined, the predetermined feature is additionally determined at least directly or by means of a second measurement method based on a second physical property that differs from the first physical property and the values of the predetermined feature obtained by means of the two measurement methods are compared.

The disadvantage in this is that the relationship between the two inspection units must first be determined in a complex manner through testing. In addition, the relationship can behave differently for different beverage processing facilities, container types, varieties and/or environmental conditions. Thus, it is complex to find a combination of results that provides a satisfactory inspection result for all beverage processing facilities, container types, varieties and/or environmental conditions.

Furthermore, there can be rare cases in which both inspection units deliver a result just below an error threshold and the container is thereby falsely classified as good.

The object of the present invention is therefore to provide a method and a device for inspecting containers that works more reliably for different beverage processing facilities, container types, varieties and/or environmental conditions.

To solve this object, the invention provides a method for inspecting containers.

Since the first measurement data and second measurement data are evaluated together by the evaluation unit with the evaluation method working on the basis of artificial intelligence to form the output data, the first measurement data and the second measurement data are already taken into account together during the evaluation. As a result, the evaluation method operating on the basis of artificial intelligence can recognize relationships between the first measurement data and the second measurement data and thus take them into account during determination. In other words, information in the first and second measurement data that cannot be individually identified can also be taken into consideration. The method according to the invention can work even more reliably as a result. Moreover, the evaluation method working on the basis of artificial intelligence can be trained in advance for different beverage processing facilities, container types, varieties and/or environmental conditions so the method no longer has to be extensively parameterized.

The method for inspecting containers can be used in beverage processing facilities. The method can be upstream, downstream or associated with a container manufacturing, cleaning, filling and/or closing process. For example, the method can be used in a full bottle or empty bottle inspection machine that comprises the inspection unit. Preferably, the method can be downstream of or associated with a filling process for filling the containers with the filling material and/or a closing process for closing the containers with a closure in order to control the fill level of the containers.

The containers can be designed to hold a filling material, such as a beverage, a food product, a hygiene product, a paste, a chemical, biological and/or pharmaceutical product. The containers can be in the form of bottles, in particular plastic bottles or glass bottles. In particular, plastic bottles can be PET, PEN, HD-PE or PP bottles. Likewise, they can be biodegradable containers or bottles whose main components consist of renewable raw materials, such as sugar cane, wheat or corn. The containers can be provided with a closure, for example, a crown cap, screw cap, tear-off cap or the like. Likewise, the containers can be present as empties, preferably without a closure.

The containers could be a specific type of container, in particular a specific shape of container. One variety can have a specific type of filling material, for example beer as opposed to a soft drink.

It is conceivable that the method can be used to inspect the side walls, base, mouth, contents and/or fill level of the containers, for example to determine contamination, such as foreign bodies, product residue, residue from labels and/or the like, or the fill level, as an inspection result. The inspection result can also relate to defects, such as damage to the containers, particularly cracks and/or chipped glass. It is also conceivable that the inspection result relates to defectively-produced material spots, such as local material thinning and/or thickening. It is also conceivable that the method is used to inspect returned reusable containers and/or to monitor the transport of the containers as a container mass flow and/or to monitor the processing of the containers in the beverage processing facilities, for example, to detect fallen containers on the transporter or a jam as the inspection result.

The containers can be transported with the transporter to the first inspection unit and/or the second inspection unit as the container mass flow, preferably as a single-lane container mass flow. However, a multi-lane container mass flow is also conceivable. The transporter can comprise a carousel and/or a linear conveyor. For example, the transporter can comprise a conveyor belt on which the containers are transported in an upright position to an inspection area of the first inspection unit and/or the second inspection unit. Receiving elements in which one or more containers are received during transport are also conceivable.

With the method, the containers can be recorded with the first inspection unit as the first measurement data and with at least the second inspection unit as the second measurement data. In other words, the containers can be recorded with the first inspection unit as the first measurement data and with the second inspection unit as the second measurement data and with at least a third inspection unit as the third measurement data. Further inspection units are also conceivable, that is, four, five, six or even more, with which the containers are recorded as further measurement data. Accordingly, the first measurement data, the second measurement data, the third measurement data and/or the further measurement data can be evaluated together by the evaluation unit with the evaluation method working on the basis of artificial intelligence to form the output data in order to determine the inspection result, such as the filling level, from the output data. It is likewise conceivable that the containers are recorded with the first inspection unit as the first measurement data and with exactly the second inspection unit as the second measurement data. The first inspection unit and the second inspection unit can be designed as an integrated inspection unit. The components, such as a sensor of the integrated inspection unit, can thus be used together by the first inspection unit and the second inspection unit, wherein different physical measurement variables can still be recorded by the containers with the first measurement data and the second measurement data.

It is conceivable that the first inspection unit, the second inspection unit, the third inspection unit and/or the further inspection units each comprise a sender and/or receiver for light, laser light, electromagnetic high-frequency waves, gamma radiation and/or for X-rays independent of one another. In other words, the first inspection unit and/or the second inspection unit can record the containers with light, laser light, electromagnetic high-frequency waves, gamma radiation and/or with X-rays. The containers can be transported between the sender and the receiver with a transporter in order to be recorded. The first inspection unit can be designed as a separate unit from the second inspection unit.

The evaluation unit can process the measurement data with a signal processor and/or with a CPU (Central Processing Unit) and/or GPU (Graphics Processing Unit) and/or with a TPU (Tensor Processing Unit) and/or with a VPU (Vision Processing Unit). It is also conceivable that the evaluation unit comprises a memory unit, one or more data interfaces, for example a network interface, a display unit and/or an input unit. Preferably, the evaluation unit can digitally process the first measurement data and/or the second measurement data in order to evaluate the output data and to determine the inspection result. The inspection result can be determined from the output data or it can comprise or be the output data.

The first measurement data, second measurement data, third measurement data and/or further measurement data can be output signals from the first inspection unit, the second inspection unit, the third inspection unit and/or the further inspection units, respectively. The first measurement data, second measurement data, third measurement data and/or the further measurement data can each be present as digital data signals. For example, they can each be present as time- and/or location-resolved, digital data signals. In particular, they can comprise image data and/or a plurality of data signals per measurement unit.

It is conceivable that containers found to be faulty based on the inspection result are discharged from the container mass flow with a switch for recycling or disposal, whereas containers found to be acceptable are transported to subsequent container treatment machines.

The evaluation method working on the basis of artificial intelligence can comprise at least one method step with a deep neural network, wherein the first measurement data and the second measurement data are evaluated together with the deep neural network for determining the output data. Thus, the processing of the first measurement data and second measurement data can be abstracted together with the deep neural network and therefore processed especially efficiently. Moreover, the deep neural network can be trained especially easily for the various beverage processing facilities, container types, kinds and/or environmental conditions. The deep neural network can comprise an input layer, several hidden layers and an output layer. The deep neural network can comprise a so-called convolutional neural network with at least one convolution layer and with a pooling layer. However, it is also conceivable that the evaluation method working on the basis of artificial intelligence comprises at least one method step with a neural network, wherein the first measurement data and the second measurement data are evaluated together with the deep neural network for determining the output data.

The first inspection unit and/or the second inspection unit can comprise at least one camera that records the containers as the first measurement data and/or the second measurement data. Thus, it is possible with simple means to record particularly extensive measurement data from the containers to determine the inspection result. Thus, for example, more complex liquid levels can be better recognized when checking the fill level, for example if there is foam above the filling material. The camera can comprise a line or matrix sensor and a lens in order to record the containers as an image. Preferably, the line or matrix sensor can detect infrared light radiation. The first measurement data and/or second measurement data can be present as image data, for example as TIFF or JPEG files. In other words, the first inspection unit and/or the second inspection unit can each be designed independently from one another as an optical inspection unit with a lighting device and with the camera in order to shine through and/or illuminate the containers. In the lighting device, light can be generated with at least one light source, for example with a light bulb, a fluorescent tube and/or with at least one LED in order to backlight a light exit surface. The light can be visible light or infrared light. Preferably, the light can be generated with a matrix of LEDs and emitted in the direction of the light exit surface. The light exit surface can comprise a diffusing disk with which the light from the at least one light source is diffusely scattered over a wide area towards the camera. It is conceivable that the light is generated by the lighting device, subsequently shines through and/or reflects off the containers, and is then recorded by the camera. The containers can be transported with the transporter between the lighting device and the camera in order to be recorded.

The second inspection unit can record the containers with a measurement method that is different from that of the first inspection unit. Thus, particularly extensive information can be recorded from the container, wherein the inspection result can be determined particularly reliably. For example, the containers can be recorded by the first inspection unit with a camera in infrared light and by the second inspection unit with a camera in visible light. It is also conceivable that the containers are recorded by the first inspection unit with a camera and by the second inspection unit with an X-ray.

In particular, the first inspection unit can comprise a first sensor and the second inspection unit a different second sensor. The first sensor and/or the second sensor can each comprise the previously-described sender and/or receiver independent of one another. For example, the sender may be the lighting device, a laser, a radio frequency source, a gamma source, and/or an X-ray source. The receiver may be the camera, a photodetector, a radio frequency receiver, a gamma detector, and/or an X-ray detector.

It is also conceivable that plausibility of the first measurement data and the second measurement data is checked during evaluation by the evaluation unit. The reliability of the inspection result can thereby be checked. For example, the first measurement data and the second measurement data can be evaluated separately from one another as a first check result and as a second check result. Should the first check result and/or the second check result of the inspection result deviate more than a predetermined threshold, then it can be concluded that there is a possible error in the inspection. It is also conceivable that accuracies of the first and/or second inspection result are compared and/or determined.

The first measurement data and the second measurement data can be combined to form common input data for the inspection unit, wherein the common input data is then evaluated by the evaluation unit with the evaluation method working on the basis of artificial intelligence to form the output data. Thus, the first and second measurement data can be processed particularly efficiently with the evaluation unit.

It is conceivable that the evaluation method working on the basis of artificial intelligence is trained with training data sets. Thus, the evaluation method working on the basis of artificial intelligence can be trained particularly easily for the various beverage processing facilities, container types, varieties and/or environmental conditions. The training data sets can comprise the first training measurement data associated with the first inspection unit and the second training measurement data associated with the second inspection unit. Moreover, the training data sets can comprise additional information associated with the first and/or the second training measurement data, in particular wherein the associated additional information characterizes output data that is associated with the first and/or second training measurement data. In other words, the associated additional information may characterize and/or comprise the inspection result associated with the respective first and/or second training measurement data. The associated additional information describes, for example, the fill level, a completely overfilled state, a completely underfilled state of the training container recorded in the first and second training measurement data and/or information on evaluability of the training measurement data. Information on the evaluability can, for example, be information relating to the presence of foam, a material defect, a label defect, a closure defect and/or the like.

The first inspection unit can record the first training measurement data of a training container and the second inspection unit can record the second training measurement data of the training container and combine them into one of the data training sets. Thus, the first inspection unit and the second inspection unit can be used to create the data training sets. However, it is also conceivable that the first training measurement data and/or the second training measurement data are recorded with further inspection units that are compatible with the first inspection unit and the second inspection unit, respectively. Thus, the training measurement data can be created by a manufacturer of a beverage processing facility.

A variety of training containers can be recorded to create the training data sets. The training data set can comprise several containers types and/or varieties to form the training data sets. Thus, a particularly large number of different container shapes and/or filling materials can be used to train the evaluation method working on the basis of artificial intelligence. Consequently, a particularly large number of different container types and/or varieties can then be subjected to inspection without the need for further adaptation of the evaluation method working on the basis of artificial intelligence.

In addition, the invention provides a device for inspecting containers to solve the object.

Since the evaluation unit is designed to evaluate the first measurement data and the second measurement data together with the evaluation method working on the basis of artificial intelligence to form the output data, the first measurement data and the second measurement are already taken into consideration together during the evaluation. Thus, the evaluation method working on the basis on artificial intelligence can recognize relationships between the first measurement data and the second measurement data and thereby take them into consideration during the determination. In other words, information in the first and second measurement data that cannot be individually identified can also be taken into consideration. The device according to the invention can work even more reliably as a result. In addition, the evaluation method working on the basis of artificial intelligence can be trained in advance for different beverage processing facilities, container types, varieties and/or environmental conditions, so that the device no longer has to be extensively parameterized.

The device can comprise the features described individually or in any combination. The device can be arranged in a beverage processing herein facility. The device can be upstream, downstream or associated with a container treatment machine, for example a container manufacturing machine, in particular a blow molding machine, a rinser, a filler, a closer and/or a packaging machine.

The device can comprise the first inspection unit and at least the second inspection unit. In other words, the device can comprise at least a third inspection unit and/or further inspection units in order to record the containers as third measurement data and/or as further measurement data. Correspondingly, the evaluation unit can be designed to evaluate the first measurement data, the second measurement data, the third measurement data and/or the further measurement data together with the evaluation method working on the basis of artificial intelligence to form the output data in order to determine the inspection result, such as the fill level, from the output data. It is also conceivable that the device only comprises the first inspection unit and the second inspection unit.

The evaluation method working on the basis of artificial intelligence can comprise a deep neural network in order to evaluate the first measurement data and the second measurement data together with the deep neural network. Thus, the joint processing of the first and second measurement data of the various beverage processing facilities, container types, varieties and/or environmental conditions can be abstracted and is therefore particularly efficient. The deep neural network can be trained particularly easily for the various beverage processing facilities, container types, varieties and/or environmental conditions. The deep neural network can comprise an input layer, one or more hidden layers and an output layer. The deep neural network can comprise a so-called convolutional neural network with at least one convolution layer and with one pooling layer. However, it is also conceivable that the evaluation method working on the basis of artificial intelligence comprises at least one method step with a neural network in order to evaluate the first measurement data and the second measurement data together with the neural network.

The first inspection unit can comprise a first sensor and the second inspection unit can comprise a different second sensor. Thus, a particularly large amount of different information can be recorded from the containers, wherein the inspection result can be determined particularly reliably. The first sensor and/or the second sensor can each comprise the sender and/or receiver described above independently of one another. For example, the sender may be the lighting device, a laser, a radio frequency source, a gamma source and/or an X-ray source. The receiver can be the camera, a photodetector, a radio frequency receiver, a gamma detector and/or an X-ray detector.

The second sensor can be designed to record the containers with a measurement method that is different from that of the first sensor. For example, the containers can be recorded by the first inspection unit with a camera in infrared light and by the second inspection unit with a camera in visible light. It is also conceivable that the containers are recorded by the first inspection unit with a camera and by the second inspection unit with an X-ray.

The device can comprise a computer system with an evaluation unit. Thus, the evaluation unit can be implemented as a computer program product. The computer system can comprise the signal processor and/or the CPU (Central Processing Unit) and/or the GPU (Graphics Processing Unit) and/or the TPU (Tensor Processing Unit) and/or the VPU (Vision Processing Unit). It is also conceivable that the computer system comprises a memory unit, one or more data interfaces, a network interface, a display unit and/or an input unit.

### BRIEF DESCRIPTION OF THE FIGURES

Further features and advantages of the invention are explained subsequently in more detail with reference to the exemplary embodiments shown in the figures. Shown is:

FIG. 1 an exemplary embodiment according to the invention of a device for inspecting containers from a top view; and

FIG. 2 an exemplary embodiment according to the invention of a method for inspecting containers as a flow chart.

### DETAILED DESCRIPTION

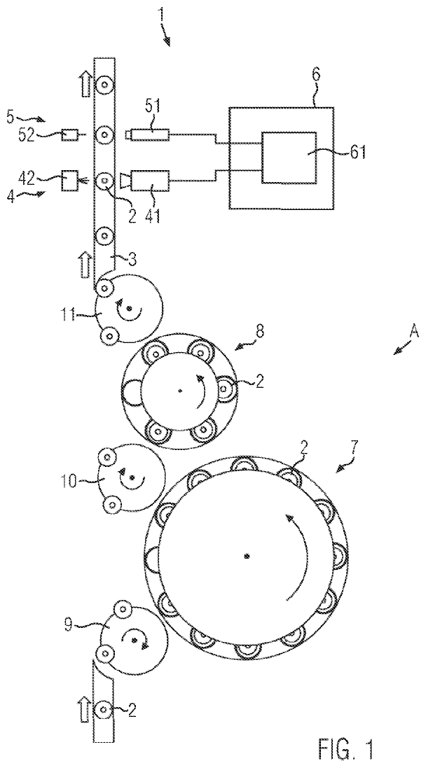

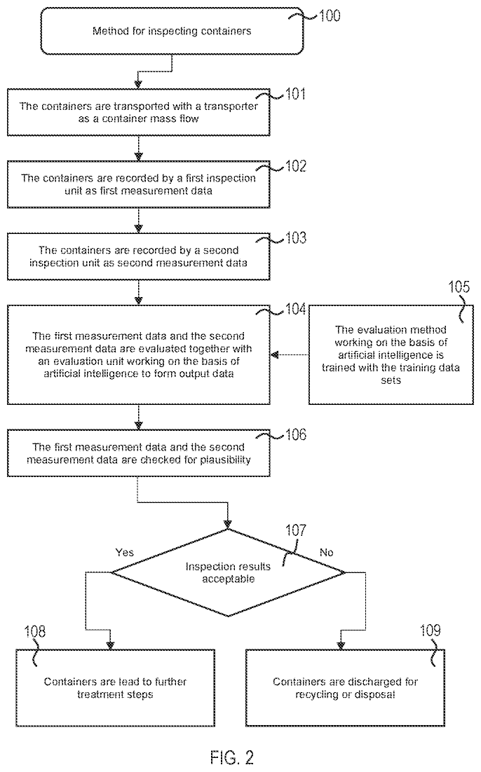

In FIG. 1, an exemplary embodiment according to the invention of a device 1 for controlling the fill level of containers 2 is presented from a top view. The device 1 is designed to carry out the method 100 described subsequently in FIG. 2.

It can be seen that the container 2 is initially transferred to the filler 7 by the infeed star wheel 7 and filled there with a filling material, for example a beverage. The filler 7 comprises, for example, a carousel with filling members arranged thereon (not shown here), which fills the container 2 with a filling material during transport. Subsequently, the containers 2 are transferred via the intermediate star wheel 10 to the closer 8, where they are provided with a closure, for example a cork, crown cap or screw cap. Thus, the filling material is protected from environmental influences and can no longer leak out the container 2.

Subsequently, the containers 2 are transferred to the conveyer 3 via the outfeed star wheel 11, which transports the containers 2 as a container mass flow to the first inspection unit 4 and the second inspection unit 5. Checking the fill level of the containers 2 is only shown as an example. The transporter 3 is designed here, for example, as a conveyor belt on which the containers 2 are transported in an upright position.

The first inspection unit 4 arranged thereon comprises a first sensor 41, 42 with the lighting device 42 as sender and the camera 41 as receiver in order to record the containers 2 in transmitted light. This can be infrared light, for example. The lighting device 42 has a diffusing light emission disk that is backlit with several LEDs and thus forms an illuminated background image for the containers 2 from the perspective of the camera. The camera 41 then records the containers 2 as first measurement data and forwards them as digital signals to the computer system 6.

Moreover, the second inspection unit 5 can be seen with the sensor 51, 52, which works with a different measuring method than the first sensor 41, 42. For example, the sender can be an X-ray source 52 and the receiver an X-ray receiver 51. The signals of the X-ray receiver 51 are recorded as second measurement data and forwarded as digital signals to the computer system 6. When the X-ray passes through the filling material, it is attenuated differently than when it passes through air or the foam above the liquid level.

Consequently, the containers 2 are recorded with two different measuring methods so that in the subsequent evaluation, the inspection result, for example the fill level, can be determined more reliably for different beverage processing facilities, container types, varieties and/or environmental conditions.

Furthermore, the computer system 6 with the evaluation unit 61 can be seen. The computer system 6 comprises, for example, a CPU, a memory unit, an input- and output unit and a network interface. Accordingly, the evaluation unit 61 is implemented as a computer program product in the computer system 6.

The evaluation unit 61 is designed to evaluate the first measurement data and the second measurement data of the containers 2 using an evaluation method working on the basis of artificial intelligence to produce output data in order to determine an inspection result, such as the fill level, from the output data.

If the inspection result of the containers 2 is acceptable, then they are lead to the further processing steps following the inspection, for example to a palletizer. In contrast, the faulty containers 2 are discharged from the container mass flow by means of a switch for recycling or disposal.

In FIG. 2, an exemplary embodiment according the invention of a method 100 for inspecting containers 2 is shown as a flowchart. The method 100 is only described as an example with reference to the device 1 previously described with reference to FIG. 1.

First, the containers 2 are transported by the transporter 3 as a container mass flow in step 101. This is done, for example, by means of a conveyor belt or a carousel. The containers 2 are transported to the first inspection unit 4 and to the second inspection unit 5.

In the following step 102, the containers 2 are recorded as first measurement data by the inspection unit 4. For example, the first sensor with the lighting device 42 and camera 41 shines through the containers 2 and records them as image data.

Moreover, the containers 2 are recorded with a different sensor in addition to the inspection unit 5 in step 103. For example, an X-ray from the X-ray source 52 passes through the containers 2 and is recorded with the X-ray receiver 51.

Since the containers 2 are recorded with the different measurement methods of the first inspection unit 4 and the second inspection unit 5, the determination of the inspection result is especially reliable.

Subsequently, in step 104, the first measurement data and the second measurement data are evaluated together by the evaluation unit 61 with an evaluation method working on the basis of artificial intelligence to produce output data in order to determine an inspection result, for example the fill level, from the output data. For this purpose, the evaluation method comprises at least one method step with a deep neural network, for example a convolutional neural network. Thereby, the first measurement data and the second measurement data first pass through an input layer, one or more convolution layers and/or hidden layers, a pooling layer and an output layer. With the output layer, the output data, for example the fill level, is output directly as the inspection result. However, it is also conceivable that the output data is further processed with one or more further method steps to form the inspection result.

Moreover, in step 106, the first measurement data and the second measurement data are checked for plausibility. This is done, for example, by evaluating the first measurement data and the second measurement data individually with a conventional evaluation method and comparing the evaluation results obtained in this way with the output data of the evaluation method based on artificial intelligence.

If the determined inspection result is acceptable according to the following step 107, then the containers 2 are led to further treatment steps in step 108. Otherwise, the containers are discharged in step 109 for recycling or disposal.

In order to teach the evaluation method working on the basis of artificial intelligence of step 104, it is trained in advance with a variety of training data sets (step 105). The training data sets each comprise first training measurement data of a training container recorded with the first inspection unit, second training measurement data of the training container recorded by the second inspection unit and associated additional information. However, it is also conceivable that the first training measurement data and/or the second training measurement data originate from other inspection units of the same type. The additional information describes, for example, the fill level, a completely overfilled state, a completely underfilled state of the training container recorded in the first and second training measurement data and/or information on evaluability of the training measurement data. Consequently, data from the input layer in the form of the first and second training measurement data and from the output layer in the form of the associated additional information are known and the deep neural network can be trained accordingly on different beverage processing facilities, container types, varieties and/or environmental conditions. Thus, the user no longer has to extensively parametierize the evaluation for the various beverage processing facilities, container types, varieties and/or environmental conditions.

Since, in the device 1 and the method 100, the first measurement data and the second measurement data are evaluated together by the evaluation unit 61 with the evaluation method working on the basis of artificial intelligence to form the output data, the first measurement data and the second measurement data are already considered together during evaluation. The evaluation method working on the basis of artificial intelligence can therefore recognize relationships between the first measurement data and the second measurement data and thus take them into consideration during determination. In other words, information in the first and second measurement data that cannot be individually identified can also be taken into consideration. Consequently, the device 1 according to the invention and the method 100 according to the invention can work even more reliably. Moreover, the evaluation method working on the basis of artificial intelligence can be trained in advance for various beverage processing facilities, containers types, varieties and/or environmental conditions, so the device 1 and the method 100 no longer have to be extensively parameterized.

It is understood that the features mentioned in the exemplary embodiments described above are not limited to these feature combinations, but that individual features or any other combination of features are also possible.

1. A method for inspecting containers, wherein the containers are transported with a transporter as a container mass flow and are recorded with a first inspection unit as first measurement data and with a second inspection unit as second measurement data,
wherein
the first measurement data and the second measurement data are evaluated together by an evaluation unit with an evaluation method working on the basis of artificial intelligence to form output data in order to determine an inspection result, for example a fill level, from the output data.

2. The method according to claim 1, wherein the evaluation method working on the basis of artificial intelligence comprises at least one method step with a deep neural network, wherein the first measurement data and the second measurement data are evaluated together with the deep neural network to determine the output data.

3. The method according to claim 1, wherein the first inspection unit and/or the second inspection unit comprises at least one camera with which the containers are recorded as the first measurement data and/or the second measurement data.

4. The method according to claim 1, wherein the second inspection unit records the containers with a measurement method that is different from that of the first inspection unit.

5. The method according to claim 4, wherein the first inspection unit comprises a first sensor and the second inspection unit comprises a different second sensor.

6. The method according to claim 1, wherein plausibility of the first measurement data and the second measurement data is checked during evaluation by the evaluation unit.

7. The method according to claim 1, wherein the first measurement data and the second measurement data are combined to form common input data for the evaluation unit, and wherein the common input data are then evaluated by the evaluation unit with the evaluation method working on the basis of artificial intelligence to form the output data.

8. The method according to claim 1, wherein the evaluation method working on the basis of artificial intelligence is trained with training data sets.

9. The method according to claim 8, wherein first training measurement data of a training container is recorded with the first inspection unit and second training measurement data of a training container is recorded with the second inspection unit and combined to form one of the training data sets.

10. The device for inspection containers for carrying out the method according to claim 1, with
a transporter for transporting the containers as a container mass flow,
a first inspection unit to record the containers as first measurement data, and
with a second inspection unit to record the containers as second measurement data,
wherein
an evaluation unit is designed to evaluate the first measurement data and the second measurement data together with an evaluation method working on the basis of artificial intelligence to form output data in order to determine an inspection result, for example a fill level, from the output data.

11. The device according to claim 10, wherein the evaluation method working on the basis of artificial intelligence comprises a deep neural network in order to evaluate the first measurement data and the second measurement data together with the deep neural network.

12. The device according to claim 10, wherein the first inspection unit comprises a first sensor and the second inspection unit comprises a different second sensor.

13. The device according to claim 12, wherein the second sensor is designed to record the containers with a measurement method that is different from that of the first sensor.
